(19) United States
(12) Patent Application Publication
(10) Pub. No.: US 2024/0388368 A1
(43) Pub. Date: Nov. 21, 2024

(54) FREQUENCY-SPLAYED MULTI-CHANNEL SYSTEM AND METHODS FOR USE THEREOF

(71) Applicant: Quantinuum LLC, Broomfield, CO (US)

(72) Inventors: Bruce Gregory Tiemann, Longmont, CO (US); Julia Rose Kahn CLINE, Louisville, CO (US)

(21) Appl. No.: 18/656,762

(22) Filed: May 7, 2024

Related U.S. Application Data
(60) Provisional application No. 63/503,231, filed on May 19, 2023.

(51) Int. Cl. H04B 10/70; H04B 10/564

(52) U.S. Cl. CPC H04B 10/70; H04B 10/564

(57) ABSTRACT

A system comprises a plurality of voltage signal sources and a controller configured to control operation of the voltage signal sources to cause them to generate respective voltage signals characterized by respective frequencies. The plurality of voltage signal sources includes a first voltage signal source adjacent a second voltage signal source and a third voltage signal source adjacent to the second voltage signal source such that the second voltage signal source is physically disposed between the first voltage signal source and the third voltage signal source. The controller causes the first voltage signal source to generate a first voltage signal characterized by a first frequency, the second voltage signal source to generate a second voltage signal characterized by a second frequency, and the third voltage signal source to generate a third voltage signal characterized by a third frequency. The first and third frequencies are different from the second frequency.

### CROSS-REFERENCE TO RELATED APPLICATIONS

This application claims priority to U.S. Application No. 63/503,231, filed May 19, 2023, the content of which is incorporated herein by reference in its entirety.

### TECHNICAL FIELD

Various embodiments relate to the use of signal frequency splay by a system that uses signals to control operation of components thereof, such as optical modulators. For example, various embodiments relate to quantum computer that uses splayed signal frequencies to reduce crosstalk between electrical and/or optical channels.

### BACKGROUND

To perform a two-qubit quantum logic gate, a quantum charge-coupled device (QCCD)-based quantum computer illuminates two qubits of the quantum computer with two optical beams that are provided to the location of the qubits via respective optical paths. The respective optical paths may include optical elements that generate leaked light of various orders and/or active optical elements that may be affected by crosstalk between electrical channels of the system. The interaction of the leaked light with qubits and/or the effect of the electrical crosstalk on the optical beams may reduce the fidelity of the two-qubit gate being performed. Through applied effort, ingenuity, and innovation, many deficiencies of such prior systems have been solved by developing solutions that are structured in accordance with the embodiments of the present invention, many examples of which are described in detail herein.

### BRIEF SUMMARY OF EXAMPLE EMBODIMENTS

Example embodiments provide systems with multiple electrical channels and/or methods for operation thereof wherein a controller of the system controls operation of voltage signals associated with respective electrical channels to generate splayed frequency signals. For example, in an example embodiment, the system comprises a first electrical channel comprising a first voltage signal source and a second electrical channel comprising a second voltage signal. The controller controls operation of a first voltage signal source to cause the first voltage signal source to generate a first voltage signal characterized by a first frequency and the controller controls operation of a second voltage signal source to cause the second voltage signal source to generate a second voltage signal characterized by a second frequency. The first frequency and the second frequency are different from one another. The difference between the first frequency and the second frequency enables the use of filtering techniques to reduce and/or remove the effects of crosstalk between the first electrical channel and the second electrical channel.

In various embodiments, the multi-channel system is a quantum computer (e.g., a quantum charge-coupled device (QCCD)-based quantum computer) and the system further includes a first optical modulator (e.g., an acousto-optical modulator (AOM)) configured to control the provision of a first optical signal to a target location and a second optical modulator (e.g., an AOM) configured to control the provision of a second optical signal to the target location. The first voltage signal is applied to the first optical modulator to control the modulation of the first optical signal by the first optical modulator and the second voltage signal is applied to the second optical modulator to control the modulation of the second optical signal by the second optical modulator. The first modulated optical signal and the second modulated optical signal are provided to the target location to enact a quantum logic gate (e.g., a single qubit gate, a multi-qubit or two-qubit gate, and/or the like) at the target location. A combination of the first and second frequencies corresponds to a set frequency value that is associated with a quantum state coupling (e.g., a frequency difference between the coupled quantum states) corresponding to the enactment of the multiple-qubit quantum logic gate. The frequency difference between the first and second frequencies is configured to reduce and/or diminish undesired quantum state coupling that may reduce the fidelity of the multiple-qubit quantum logic gate.

According to one aspect of the present disclosure, a method for performing a quantum logical operation is provided. The method is performed by a controller configured to control operation of one or more components of a quantum computer. The method includes controlling operation of a first voltage signal source to generate a first voltage signal having a first frequency; and controlling operation of a second voltage signal source to generate a second voltage signal having a second frequency. The first voltage signal is provided to a first optical modulator configured to modulate a first optical signal based at least in part on the first frequency. The second voltage signal provided to a second optical modulator configured to modulate a second optical signal based at least in part on the second frequency. A combination of the first frequency and the second frequency corresponds to a set frequency value. The first frequency is different from the second frequency.

In an example embodiment, a sum of (a) a frequency difference between a frequency of the first optical signal and a frequency of the second optical signal and (b) the set frequency value corresponds to a quantum state transition corresponding to the quantum logic gate.

In an example embodiment, the first voltage signal source is a first direct digital synthesizer and controlling operation of the first voltage signal source comprises providing, by the controller, a tuning word to the first direct digital synthesizer.

According to another aspect, a system is provided. In various embodiments, the system includes one or more pairs of voltage signal sources; and a controller configured to control operation of the one or more pairs of voltage signal sources. The one or more pairs of voltage signal sources includes a first pair of voltage signal sources that includes a first voltage signal source and a second voltage signal source. The controller is configured to cause the first voltage signal source of the first pair of voltage signal sources to generate a first voltage signal characterized by a first frequency. The controller is configured to cause the second voltage signal source of the first pair of voltage signal sources to generate a second voltage signal characterized by a second frequency. A combination of the first frequency and the second frequency corresponds to a set frequency value. The first frequency is different from the second frequency.

In an example embodiment, the one or more pairs of voltage signal sources further comprises a second pair of voltage signal sources, the second pair of voltage signal sources comprising a third voltage signal source and a fourth voltage signal source, the controller is configured to cause the third voltage signal source of the second pair of voltage signal sources to generate a third voltage signal characterized by a third frequency, the controller is configured to cause the fourth voltage signal source of the second pair of voltage signal sources to generate a fourth voltage signal characterized by a fourth frequency, a combination of the third frequency and the fourth frequency corresponds to the set frequency value, and the third frequency is different from the fourth frequency.

In an example embodiment, each of the first frequency, the second frequency, the third frequency, and the fourth frequency are different from one another.

In an example embodiment, a respective frequency difference between a respective two of the first frequency, the second frequency, the third frequency, and the fourth frequency is in a range of 1 MHz to 100 MHz.

In an example embodiment, at least two voltage signal sources of the one or more pairs of voltage signal sources are mounted within a chassis and the controller is configured to cause the at least two voltage signal sources to generate respective voltage signals at respective frequencies that are different from one another.

In an example embodiment, the controller is configured to control operation of a first additional component of the system via application of the first voltage signal to the first additional component and to control operation of a second additional component of the system via application of the second voltage signal to the second additional component.

In an example embodiment, the first additional component comprises a first optical modulator and the second additional component comprises a second optical modulator.

In an example embodiment, the first voltage signal is applied to the first optical modulator to cause the first optical modulator to modulate a first optical signal to provide a first modulated optical signal and the second voltage signal is applied to the second optical modulator to cause the second optical modulator to modulate a second optical signal to provide a modulated optical signal, wherein the first modulated optical signal and the second modulated optical signal are applied to a target location to cause a quantum logic gate to be performed on one or more quantum objects disposed at the target location.

In an example embodiment, a sum of (a) a frequency difference between a frequency of the first optical signal and a frequency of the second optical signal and (b) the set frequency value corresponds to a quantum state transition corresponding to the quantum logic gate.

In an example embodiment, the first modulated optical signal is filtered using at least one of spatial filtering or optical filtering.

In an example embodiment, the spatial filtering is performed by coupling the first modulated optical signal into an optical fiber configured to carry the first modulated optical signal along at least a portion of an optical path from the first optical modulator to the target location.

In an example embodiment, the first voltage signal is applied to the first additional component via a first electrical connection and the second voltage signal is applied to the second additional component via a second electrical connection.

In an example embodiment, the first electrical connection comprises a filter configured to pass a portion of an electrical signal carried by the first electrical connection and characterized by the first frequency and to dampen a portion of the electrical signal carried by the first electrical connection and characterized by the second frequency.

In an example embodiment, a frequency difference between the first frequency and the second frequency is in a range of 1 MHz and 100 MHz.

In an example embodiment, the controller provides a first tuning word to cause the first voltage signal source to cause the first voltage source to generate the first voltage signal with the first voltage.

According to yet another aspect, a system is provided. In an example embodiment, the system includes a plurality of voltage signal sources mounted in a chassis, and a controller configured to control operation of the voltage signal sources to cause the voltage signal sources to generate respective voltage signals characterized by respective frequencies. The plurality of voltage signal sources includes a first voltage signal source, a second voltage signal source, and a third voltage signal source. The first voltage signal source is adjacent the second voltage signal source and the third voltage signal source is adjacent to the second voltage signal source such that the second voltage signal source is disposed between the first voltage signal source and the third voltage signal source. The controller causes the first voltage signal source to generate a first voltage signal characterized by a first frequency, the second voltage signal source to generate a second voltage signal characterized by a second frequency, and the third voltage signal source to generate a third voltage signal characterized by a third frequency. The first frequency is different from the second frequency, and the second frequency is different from the third frequency.

In an example embodiment, a frequency difference between the first frequency and the second frequency is larger than a frequency difference between the first frequency and the third frequency.

According to still another aspect, a system is provided. In an example embodiment, the system includes one or more sets of voltage signal sources; and a controller configured to control operation of the one or more sets of voltage signal sources. The one or more sets of voltage signal sources comprises one or more first voltage signal sources and one or more second voltage signal sources. The controller is configured to cause the one or more first voltage signal sources and the one or more second voltage signal sources to generate respective voltage signals characterized by respective frequencies. The respective voltage signals generated by the one or more first voltage signal sources are applied to respective optical modulators along a first beam path to modify an optical beam traversing the first beam path by a first frequency. The respective voltage signals generated by the one or more second voltage signal sources are applied to respective optical modulators along a second beam path to modify an optical beam traversing the second beam path by a second frequency. The respective frequencies are different from one another. A combination of the first frequency and the second frequency corresponds to a set frequency value, and the first frequency is different from the second frequency.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of at least a portion of a frequency-splayed multi-channel system, in accordance with an example embodiment.

FIG. 2 provides a block diagram of an example QCCD-based quantum computer including frequency-splayed channels, in accordance with an example embodiment.

FIG. 3A provides a schematic diagram of a conventional quantum logical operation that is affected by leaked light.

FIG. 3B provides a schematic diagram of a quantum logical operation, in accordance with an example embodiment, such that the effect of leaked light is reduced and/or diminished.

FIG. 4 provides a flowchart illustrating various processes performed by a controller, in accordance with an example embodiment.

FIGS. 5A, 5B, and 5C provide respective schematic diagrams of portions of respective frequency-splayed multiple channel systems that use filtering, in accordance with example embodiments.

FIG. 6 provides a schematic diagram of an example controller of a system comprising frequency-splayed channels, in accordance with an example embodiment.

FIG. 7 provides a schematic diagram of an example computing entity of a system comprising a QCCD-based quantum computer including frequency-splayed channels that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

Various embodiments provide frequency-splayed multi-channel systems, such as quantum computers that include multiple electrical channels, and methods of operating multi-channel systems. In various embodiments, the frequency-splayed multi-channel systems comprise a plurality of electrical channels. For example, the frequency-splayed multi-channel systems comprise a plurality of voltage signal generators such as direct digital synthesizers (DDSs), arbitrary waveform generators (AWGs), digital-to-analog converters (DACs), and/or the like. In various embodiments, each of the plurality of voltage signal generators is configured to generate a respective radio frequency (RF) electrical and/or voltage signal. For example, the electrical and/or voltage signal generated by a respective voltage signal generator of the plurality of voltage signal generators is characterized by a respective RF frequency.

In various embodiments, the respective electrical and/or voltage signals generated by the plurality of voltage signal generators are applied to one or more additional components of the system to control operation of the respective additional components. For example, the additional components may include RF electrodes and/or RF rails (e.g., of a confinement apparatus such as a surface ion trap and/or the like), optical modulators (e.g., AOMs, electro-optical modulators (EOMs), and/or the like), and/or other components configured to be operationally controlled, at least in part, through application of an electrical and/or voltage signal thereto.

In an example embodiment, the system is a quantum computer comprising a plurality of optical modulators (e.g., AOMs, EOMs, and/or the like). Each of the plurality of optical modulators is part of a respective beam path system configured for providing an optical beam and/or signal (e.g., a laser beam, series of laser pulses, microwave beam and/or pulses, and/or the like) from a signal source (e.g., a laser, microwave generator, and/or the like) to a target location. In an example embodiment, the target location is a location defined at least in part by a confinement apparatus configured to confine a plurality of quantum objects. For example, the confinement apparatus is configured to confine one or more quantum objects at the target location such that a single qubit gate or multi-qubit gate may be performed on the one or more quantum objects disposed at the target location.

In various embodiments, the quantum objects confined by the confinement apparatus are used as qubits of the quantum computer. In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals and the confinement apparatus is an ion trap, such as a surface ion trap, Paul ion trap, and/or the like.

In various embodiments, the multiple-qubit gate is a quantum logical operation configured to cause a gate coupling of two quantum states of the quantum objects so as to enact and/or impart the logical operation of the quantum logical operation. The gate coupling of the multiple quantum objects is caused by application of two optical signals to the target location where the frequency difference between the two optical signals corresponds to (e.g., is slightly detuned from) a frequency corresponding to the energy difference between the two quantum states coupled by the gate coupling. In various embodiments, the first optical signal is a modulated optical signal that has been modulated by a first optical modulator in accordance with a first electrical and/or voltage signal applied thereto. The second optical signal is a modulated optical signal that has been modulated by a second optical modulator in accordance with a second electrical and/or voltage signal applied thereto. In various embodiments, the first electrical and/or voltage signal and the second electrical and/or voltage signal are configured to enable performance of the multiple-qubit gate (or a single qubit gate) while reducing and/or diminishing the chances of undesired couplings of quantum states of the quantum objects as a result of leaked light of various orders leaked from the first optical modulator and/or the second optical modulator.

In conventional multi-channel systems, voltage signal sources configured to generate electrical and/or voltage signals that are to be used to perform the same task (e.g., control operation of similar optical modulators configured to perform similar tasks in the multi-channel system) are operated to generate electrical and/or voltage signals of the same frequency. For example, a plurality of 200 MHz AOMs may be operated to generate electrical and/or voltage signals of 200 MHz. When the voltage signal sources are located close to one another or the electrical wires configured to enable electrical communication between respective voltage signal sources and respective additional components are close to one another, electrical crosstalk may occur between different electrical channels. Such electrical crosstalk between different electrical channels may degrade the operations of the multi-channel system. For example, when the multi-channel system is a quantum computer that performs operations that are controlled, at least in part, based on the electrical and/or voltage signals generated by respective voltage signal sources, the integrity and/or fidelity of the performed operations may be degraded and/or reduced as a result of the electrical crosstalk between the different electrical channels. Therefore, technical problems exist regarding operation of multi-channels systems.

Additionally, crosstalk between electrical signals that are being applied to optical modulators can cause an optical modulator to provide light of the first diffracted order when the electrical signal intended to control operation of the optical modulator is configured to cause the optical modulator to not provide light (e.g., the electrical signal intended to control operation of the optical modulator is configured to cause the optical modulator to be in an off state). This leads to additional noise and undesired light scattering in the multi-channel system.

Various embodiments provide technical solutions to these technical problems. For example, various embodiments provide frequency-splayed multi-channel systems. For example, the voltage signal sources located adjacent to one another are operated to generate electrical and/or voltage signals characterized by different frequencies, in various embodiments. In an example embodiment, each of the plurality of voltage signal sources is operated to generate a respective electrical and/or voltage signal that is characterized by a different frequency than the other electrical and/or voltage signals generated by the other voltage signal sources of the plurality of voltage signal sources. For example, a first voltage signal source is operated to generate an electrical and/or voltage signal characterized by a first frequency and a second voltage signal source is operated to generate an electrical and/or voltage signal characterized by a second frequency, where the first and second frequencies are different from one another. For example, the frequency difference between the first frequency and the second frequency is at least 1 MHZ (e.g., in a range of 1 MHz to 100 MHz, in an example embodiment). Thus, any crosstalk between the first channel comprising the first voltage signal source and the second channel comprising the second voltage signal source may be removed and/or dampened using various filtering techniques. Thus, the effect of any crosstalk between the first channel and the second channel (e.g., on the integrity and/or fidelity of any operations controlled, at least in part, via the first channel and/or the second channel) is reduced and/or diminished. Therefore, various embodiments provide technical advantages and improvements to the operating of multi-channel systems.

Moreover, in conventional quantum computers that use optical modulators to, at least in part, control provision of two or more optical signals to a target location to enact a quantum logical operation (e.g., a single qubit gate, a multi-qubit and/or two-qubit gate, and/or the like), leaked light from one or more of the optical modulators of various orders may cause undesired coupling between various quantum states of the quantum objects disposed at the target location.

For example, when an optical beam is modulated by an optical modulator, the majority of the optical beam is modulated in accordance with the frequency that characterizes the electrical and/or voltage signal applied to the optical modulator. This is referred to as first order modulation. Some of the optical beam is modulated in accordance with the second harmonic of the frequency (e.g., two times the frequency) that characterizes the electrical and/or voltage signal applied to the optical modulator. This is referred to as second order modulation. Some of the optical beam may not be modulated at all, which is referred to as zeroth order modulation. The desired modulated optical signals are the first order modulated optical signals. However, the leaked light (e.g., zeroth order portion of the modulated optical signals, second order portion of the modulated optical signals, third order portion of the modulated optical signals, etc.) will also be incident on the multiple quantum objects disposed at the target location. This leaked light may result in undesired coupling of quantum states of the multiple quantum objects. For example, the zeroth order portion of the first modulated optical signal and the second order portion of the second modulated optical signal may interact with the quantum objects disposed at the target location to cause an undesired coupling quantum states of the multiple quantum objects.

In various scenarios, the first modulated optical signal and second modulated optical signal are provided to the target location to cause performance of a quantum logic operation. For example, the (first order portion of the) first modulated optical signal and the (first order portion of the) second modulated optical signal being incident on the multiple quantum objects disposed at the target location causes a multiple qubit (e.g., two-qubit) gate to be performed on the multiple quantum objects. The undesired coupling of the quantum states of the multiple quantum objects caused by the leaked light being incident on the multiple quantum objects disposed at the target location may reduce and/or degrade the fidelity of the quantum logic operation performed on the multiple quantum objects. Similarly, undesired coupling of quantum states of a quantum object embodying a qubit may reduce and/or degrade the fidelity of a single qubit gate. Thus, technical problems exist regarding performing high fidelity quantum logical operations.

Various embodiments provide technical solutions to these technical problems. For example, in an example embodiment, a first voltage signal source is operated to generate a first electrical and/or voltage signal characterized by a first frequency and that is used to control the operation of a first optical modulator. A second voltage signal source is operated to generate a second electrical and/or voltage signal characterized by a second frequency and that is used to control the operation of a second optical modulator. The first optical modulator modulates a first optical signal so as to provide a first (first order) modulated optical signal that has a frequency that is increased, with respect to the frequency of the first optical signal, by the first frequency. The second optical modulator modulates a second optical signal so as to provide a second (first order) modulated optical signal that has a frequency that is decreased, with respect to the frequency of the second optical signal, by the second frequency. In various embodiments, the combination of the first frequency and the second frequency corresponds to a set frequency value that is configured to enable the (first order) modulated optical signals to cause the gate coupling so as to enact the quantum logical operation (e.g., single qubit gate, multi-qubit and/or two-qubit gate). The first frequency and the second frequency are different from one another (e.g., have a frequency difference of at least 1 MHZ). Since the first frequency and the second frequency are not equal to one another, the ability of the leaked light to cause undesired coupling of quantum states of the quantum objects is decreased and/or reduced.

Moreover, the splaying of the frequencies and filtering reduces the first order light emitted by an optical modulator that is intended to be “off” and/or to not provide an optical beam at that time.

Therefore, various embodiments provide technical advantages and improvements to the operation of systems having multiple electrical channels, quantum computers and high fidelity quantum logical operations.

### Example Frequency-Splayed Multi-channel System

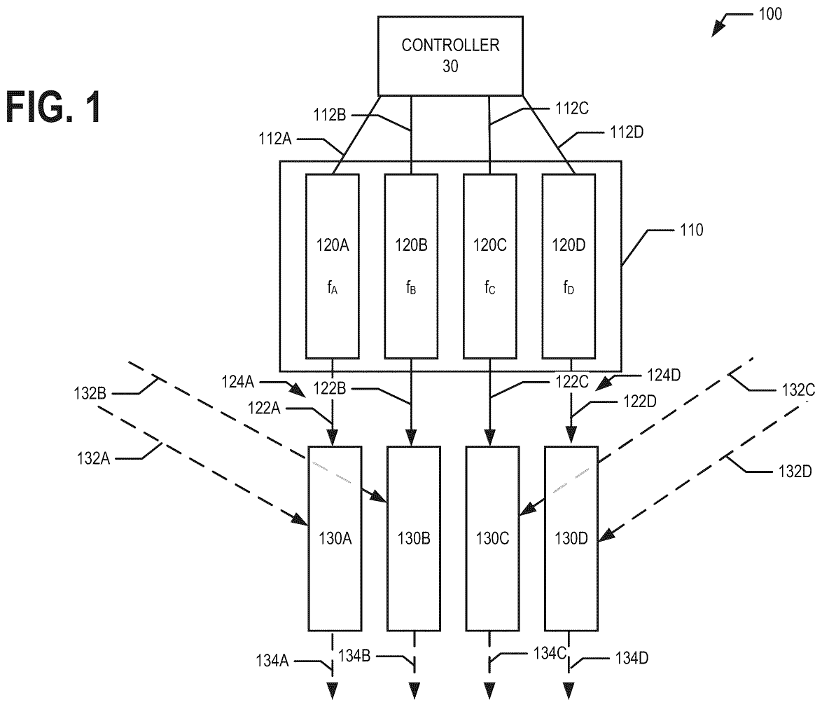

FIG. 1 illustrates an example frequency-splayed multi-channel system 100. In various embodiments, the frequency-splayed multi-channel system 100 comprises a plurality of channels. For example, in the illustrated embodiment, a first channel comprises a first voltage signal source 120A (e.g., DDS, AWG, DAC, and/or the like) configured to generate a first electrical and/or voltage signal 122A characterized by a first frequency f_{A}, which is provided through a first electrical connection 124A (e.g., conductive wires, cables, leads, traces, and/or the like and/or a combination thereof) to a first optical modulator 130A (e.g., an AOM, EOM, and/or the like) which modulates a first optical signal 132A based at least in part on the first electrical and/or voltage signal 122A to generate and/or provide a first modulated optical signal 134A.

A second channel of the frequency-splayed multi-channel system 100 comprises a second voltage signal source 120B (e.g., DDS, AWG, DAC, and/or the like) configured to generate a second electrical and/or voltage signal 122B characterized by a second frequency f_{B}, which is provided through a second electrical connection (e.g., conductive wires, cables, leads, traces, and/or the like and/or a combination thereof) to a second optical modulator 130B (e.g., an AOM, EOM, and/or the like) which modulates a second optical signal 132B based at least in part on the second electrical and/or voltage signal 122B to generate and/or provide a second modulated optical signal 134B.

A third channel of the frequency-splayed multi-channel system 100 comprises a third voltage signal source 120C (e.g., DDS, AWG, DAC, and/or the like) configured to generate a third electrical and/or voltage signal 122C characterized by a third frequency fc, which is provided through a third electrical connection (e.g., conductive wires, cables, leads, traces, and/or the like and/or a combination thereof) to a third optical modulator 130C (e.g., an AOM, EOM, and/or the like) which modulates a third optical signal 132C based at least in part on the third electrical and/or voltage signal 122C to generate and/or provide a third modulated optical signal 134C.

A fourth channel of the frequency-splayed multi-channel system 100 comprises a fourth voltage signal source 120D (e.g., DDS, AWG, DAC, and/or the like) configured to generate a fourth electrical and/or voltage signal 122D characterized by a fourth frequency f_{D}, which is provided through a fourth electrical connection 124D (e.g., conductive wires, cables, leads, traces, and/or the like and/or a combination thereof) to a fourth optical modulator 130D (e.g., an AOM, EOM, and/or the like) which modulates a fourth optical signal 132D based at least in part on the fourth electrical and/or voltage signal 122D to generate and/or provide a fourth modulated optical signal 134D.

While the illustrated embodiment includes four channels, various embodiments may include various numbers of channels. For example, various embodiments include two to five hundred channels. Some embodiments include more than five hundred channels. In an example embodiment, the system includes one channel that generates and/or operates via a voltage signal characterized by a frequency that is distinct from the frequency of other voltage signals used in the system so as to reduce electrical crosstalk between the singe channel and other nearby electrical components/systems.

While the illustrated embodiment includes optical modulators 130 (e.g., 130A, 130B, 130C, 130D) as the additional components to which the electrical and/or voltage signals are applied, various embodiments may include various additional components. For example, the frequency-splayed multi-channel system may include electrodes (e.g., RF rails) and/or other components configured to be operationally controlled, at least in part, through application of an electrical and/or voltage signal thereto. Various embodiments include a combination of additional components (e.g., one or more optical modulators and one or more electrodes, for example).

In various embodiments, the frequency-splayed multi-channel system 100 includes a controller 30. In various embodiments, the controller 30 is configured to control operation of the voltage signal sources 120 (e.g., 120A, 120B, 120C, 120D). For example, in various embodiments, the controller 30 provides a respective control signal 112 (e.g., 112A, 112B, 112C, 112D) to each voltage signal source 120 to cause the voltage signal source 120 to generate respective electrical and/or voltage signals 122 (e.g., 122A, 122B, 122C, 122D) that are characterized by respective frequencies.

In an example embodiment, a respective voltage signal source 120 is a DDS and the respective control signal 112 includes a tuning word corresponding to the respective frequency. For example, the respective frequency fᵢ is related to the tuning word through the relationship

$${f}_{i} = \frac{M * {f}_{c}}{{2}^{N}} ,$$

where M is the tuning word, f_{c} is the system clock frequency (e.g., the frequency of a clock of the controller 30 or a frequency of a clock local to the respective voltage signal source), and N is the length (e.g., number of bits) of the phase accumulator of the respective voltage signal source.

In various embodiments, a plurality of voltage signal sources 120 are mounted within the same chassis, frame, or mounting block 110. For example, the voltage signal sources 120A, 120B, 120C, and 120D are formed on respective circuit cards and mounted within a common chassis, frame, or mounting block 110. In the illustrated embodiment, the first voltage signal source 120A is adjacent the second voltage signal source 120B (e.g., there are no voltage signal sources disposed between the first and second voltage signal sources 120A, 120B). In other words, the first voltage signal source 120A and the second voltage signal source 120B are nearest neighbors, in the illustrated embodiment of FIG. 1. Similarly, the second voltage signal source 120B and the third voltage signal source 120C are adjacent one another and/or nearest neighbors. The first voltage signal source 120A and the third voltage source 120C are not nearest neighbors, in the illustrated embodiment of FIG. 1. In various embodiments, the first frequency f_{A}, which characterizes the first electrical and/or voltage signal 122A generated and/or provided by the first voltage signal source 120A, is different from the second frequency f_{B}, which characterizes the second electrical and/or voltage signal 122B generated and/or provided by the second voltage signal source 120B. In various embodiments, the second frequency f_{B}, which characterizes the second electrical and/or voltage signal 122B generated and/or provided by the second voltage signal source 120B, is different from the third frequency f_{C}, which characterizes the third electrical and/or voltage signal 122C generated and/or provided by the third voltage signal source 120C. For example, |f_{A}−f_{B}|>0 and |f_{B}−f_{C}>0.

In an example embodiment, the first frequency f_{A} and the third frequency f_{C} are equal to one another and the second frequency f_{B} and the fourth frequency f_{D} are equal to one another but the first frequency f_{A} and the third frequency f_{C} are different from the second frequency f_{B} and the fourth frequency f_{D}(e.g., f_{A}=f_{C}≠f_{B}=f_{D}).

In an example embodiment, each of the first frequency f_{A}, the second frequency f_{B}, the third frequency f_{c}, and the fourth frequency f_{D} are different from each other. For example, none of the first frequency f_{A}, the second frequency f_{B}, the third frequency f_{c}, and the fourth frequency f_{D} is equal to another of the first frequency f_{A}, the second frequency f_{B}, the third frequency f_{c}, and the fourth frequency f_{D}(e.g., fᵢ≠fⱼ∀i‥j).

In an example embodiment, the frequency difference between adjacent and/or nearest neighbor voltage signal sources is larger than the frequency difference between non-nearest neighbor voltage signal sources. For example, the frequency difference between the first frequency f_{A} and the second frequency f_{B} is larger than the frequency difference between the first frequency f_{A} and the third frequency f_{C}, in an example embodiment (e.g., |f_{A}−f_{B}|>|f_{A}−f_{C}|). For example, in an example embodiment, the frequency difference between nearest neighbor voltage signal sources is at least 2 MHZ, and the frequency difference between non-nearest neighbor voltage signals sources is at least 1 MHz. In various embodiments, the frequency difference between adjacent and/or nearest neighbor voltage signal sources or non-nearest voltage signal sources may be as large as 50 or 100 MHZ.

In various embodiments, the plurality of voltage signal sources 120 are organized into pairs of voltage signal sources. For example, in the illustrated embodiment, the first voltage signal source 120A and the second voltage signal source 120B are organized as a pair of voltage signal sources and the third voltage signal source 120C and the fourth voltage signal source 120D are organized as a pair of voltage signal sources. For example, the controller 30 is configured to control the first voltage signal source 120A and the second voltage signal source 120B in a coordinated manner. Similarly, the controller 30 is configured to control the third voltage signal source 120C and the fourth voltage signal source 120D in a coordinated manner.

For example, in an example embodiment, the first electrical and/or voltage signal 122A is configured to operate and/or control operation of a first additional component of the frequency-splayed multi-channel system 100 (e.g., the first optical modulator 130A) and the second electrical and/or voltage signal 122B is configured to operate and/or control operation of a second additional component of the frequency-splayed multi-channel system 100 (e.g., the second optical modulator 130B). The result of the operation of the first additional component and the result of the operation of the second additional component are used in a coordinated manner to perform one or more functions of the frequency-splayed multi-channel system 100. For example, the first electrical and/or voltage signal 122A operates and/or causes operation of a first optical modulator 130A to cause the first optical modulator 130A to modulate a first optical signal 132A to provide a first modulated optical signal 134A and the second electrical and/or voltage signal 122B operates and/or causes operation of a second optical modulator 130B to cause the second optical modulator 130B to modulate a second optical signal 132B to provide a second modulated optical signal 134B. The first modulated optical signal 134A and the second modulated optical signal 134B are used to perform a function of the frequency-splayed multi-channel system 100. For example, in an example embodiment, the frequency-splayed multi-channel system 100 is and/or is part of a quantum computer and the first modulated optical signal 134A and the second modulated optical signal 134B are used to perform a quantum logical operation (e.g., a single qubit gate, a multi-qubit or two-qubit gate, and/or the like).

### Example Quantum Computer

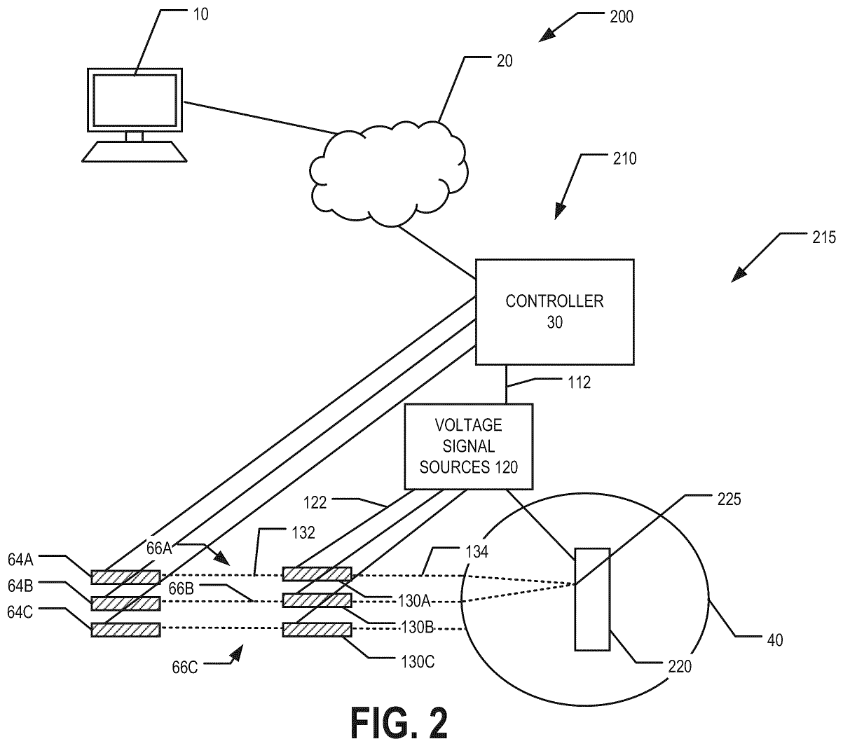

In various embodiments, the frequency-splayed multi-channel system 100 is and/or is part of a quantum computer. For example, the frequency-splayed multi-channel system 100 is part of a QCCD-based quantum computer in the embodiment illustrated by FIG. 2.

For example, the quantum computing system 200 comprises a (classical and/or semi-conductor-based) computing entity 10 and a quantum computer 210. In various embodiments, the quantum computer 210 comprises a controller 30 and a quantum processor 215. In various embodiments, the controller is configured to control a plurality of voltage signal sources 120. The plurality of voltage signal sources 120 generate respective electrical signals that are provided to respective optical modulators 130 and/or other electrical components of the quantum computing system 200. The controller, in various embodiments, is further configured to control operation of one or more manipulation sources 64 (e.g., 64A, 64B, 64C). For example, the manipulation sources (e.g., lasers, microwave sources, and/or the like) may be configured to generate optical signals (e.g., laser beams and/or pulses and/or the like) that are provided to and modulated by the optical modulators 130.

In various embodiments, the quantum processor 215 comprises a confinement apparatus 220 that is configured to confine a plurality of quantum objects such that the respective quantum states of the quantum objects may be manipulated, evolved in a controlled manner (e.g., in accordance with a quantum circuit), and/or the like. For example, quantum operation functions (quantum logical operations, single qubit gates, multi-qubit and/or two-qubit gates, initialization, reading and/or measurement operations, and/or the like) may be performed on quantum objects disposed at respective target locations 225 defined by the confinement apparatus 220 and/or the quantum processor 215. For example, the confinement apparatus 220 is configured to maintain one or more quantum objects at respective target locations 225 such that respective quantum operations may be performed one the one or more quantum objects.

In various embodiment, the quantum processor 115 comprises a cryogenic and/or vacuum chamber 40 enclosing a confinement apparatus 220, one or more manipulation sources 64 (e.g., 64A, 64B, 64C), respective beam path systems 66 (e.g., 66A, 66B, 66C) configured for providing respective manipulation and/or optical signals to respective target locations 225 defined at least in part by the confinement apparatus 220, one or more voltage signal sources 120, one or more magnetic field sources, an optics collection system, and/or the like. In various embodiments, the controller 30 is configured to control the operation of (e.g., control one or more drivers configured to cause operation of) the manipulation sources 64, beam path systems 66, voltage signal sources 120, magnetic field sources, a vacuum system and/or cryogenic cooling system, and/or the like. In various embodiments, the controller 30 is configured to receive signals (e.g., electrical signals) generated and provided by the optics collection system.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects confined by the confinement apparatus 220. For example, a first manipulation source 64A is configured to generate and/or provide a first manipulation and/or optical signal and a second manipulation source 64B is configured to generate and/or provide a second manipulation and/or optical signal, where the first and second manipulation and/or optical signals are configured to perform one or more quantum operations (e.g., single qubit gates, multi-qubit and/or two-qubit gates, cooling, initialization, reading/measurement, and/or like) on quantum objects confined by the confinement apparatus 220.

In an example embodiment, the one or more manipulation sources 64 each provide a manipulation and/or optical signal (e.g., laser beam and/or the like) to one or more portions (e.g., target locations 225) of the confinement apparatus 220 via corresponding beam path systems 66 (e.g., 66A, 66B, 66C). In various embodiments, at least one beam path system 66 comprises an optical modulator 130 configured to modulate the manipulation and/or optical signal being provided to the confinement apparatus 220 via the beam path system 66. In various embodiments, the manipulation sources 64, active components of the beam path systems 66 (e.g., optical modulators 130 and/or the like), and/or other components of the quantum computer 210 are controlled by the controller 30. For example, the controller 30 controls operation of the voltage signal sources 120 (e.g., via respective control signals 112) such that respective voltage signal sources 120 generate and provide respective electrical and/or voltage signals 122, which are characterized by respective frequencies, and are applied to the respective optical modulators 130 to control operation thereof.

In various embodiments, the confinement apparatus 220 is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus 220 is an appropriate confinement apparatus for confining the quantum objects of the embodiment.

In various embodiments, the quantum computer 210 comprises one or more voltage signal sources 120. For example, the voltage sources may be AWGs, DACs, DDSs, and/or other voltage signal generators. For example, the voltage signal sources 120 may comprise a plurality of control voltage drivers and/or voltage sources and/or at least one RF driver and/or voltage source. Some of the voltage signal sources 120 may be electrically coupled to the corresponding potential generating elements (e.g., control electrodes and/or RF electrodes) of the confinement apparatus 220, in an example embodiment.

In various embodiments, at least a portion of the beam path systems 66 are disposed or located within the cryogenic and/or vacuum chamber 40. For example, in an example embodiment, one or more of the optical modulators 130 are disposed or located within the cryogenic and/or vacuum chamber 40. In an example embodiment, one or more of the manipulation sources 64 and one or more of the optical modulators 130 are disposed or located within the cryogenic and/or vacuum chamber 40. In the example embodiment illustrated in FIG. 2, both the manipulation sources 64 and the optical modulators 130 are disposed or located outside of the cryogenic and/or vacuum chamber 40.

In various embodiments, the quantum computing system 200 includes a classical computing entity 10. The computing entity 10 is configured to allow a user to provide input to the quantum computer 210 (e.g., via a user interface of the computing entity 10) and receive, view, and/or the like output from the quantum computer 210. The computing entity 10 may be in communication with the controller 30 of the quantum computer 210 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage signal sources 120, magnetic field sources, cryogenic system and/or vacuum system controlling the temperature and/or pressure within the cryogenic and/or vacuum chamber 40, manipulation sources 64, beam path systems 66, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus 220, and/or read and/or measure a quantum (e.g., qubit) state of one or more quantum objects within the confinement apparatus. For example, the controller 30 may cause a controlled evolution of quantum states of one or more quantum objects confined by the confinement apparatus 220 (e.g., by performing a sequence of quantum logical operations) to execute a quantum circuit and/or algorithm. For example, the controller 30 may read and/or detect quantum states of one or more quantum objects within the confinement apparatus 220 at one or more points during the execution of a quantum circuit. In various embodiments, the quantum objects confined by the confinement apparatus are used as qubits of the quantum computer 210.

### Example Performance of a Quantum Logical Operation

In conventional quantum computers that use optical modulators to, at least in part, control provision of two or more optical signals to a target location to enact a quantum logical operation (e.g., a single qubit gate, a multi-qubit and/or two-qubit gate, and/or the like), leaked light from one or more of the optical modulators of various orders may cause undesired coupling between various quantum states of the quantum objects disposed at the target location.

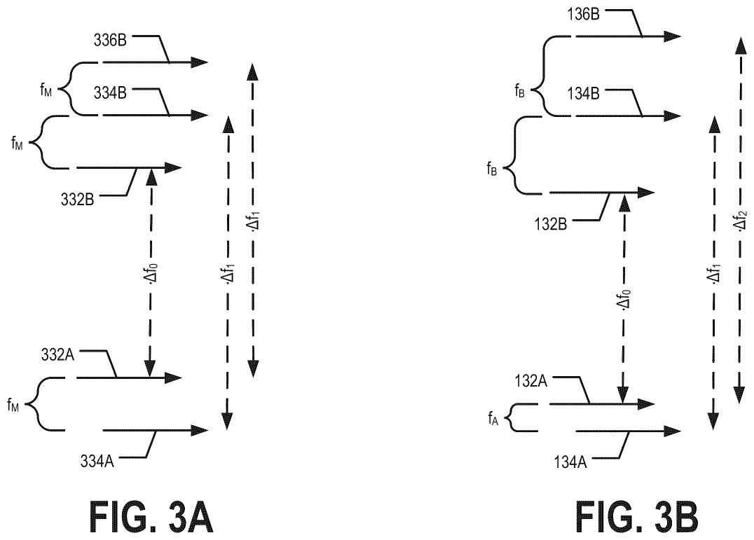

For example, FIG. 3A provides a schematic diagram in frequency space of the performance of a quantum logic operation. For example, a first manipulation signal 332A characterized by a first optical frequency f₁ is modulated by a first optical modulator to generate a first modulated manipulation signal 334A. For example, the (first order portion of the) first modulated manipulation signal 334A is shifted and/or decreased in frequency from its original frequency by the modulator frequency f_{M}, where f_{M} is the frequency of the electrical and/or voltage signal applied to the first optical modulator to control operation thereof. For example, the first order portion of the first modulated manipulation signal 334A is characterized by the optical frequency f₁−f_{M}. The manipulation signal applied to the target location 225 generally also includes a zeroth order portion of the first modulated manipulation signal that is characterized by the original frequency of the first manipulation signal f₁ and higher order portions (e.g., second order portions and/or the like).

A second manipulation signal 332B characterized by a second optical frequency f₂ is modulated by a second optical modulator to generate a second modulated manipulation signal 334B. The first optical frequency and the second optical frequency are different from one another (e.g., f₁−f₂≠0). For example, the (first order portion of the) second modulated manipulation signal 334B is shifted and/or increased in frequency from its original frequency by the modulator frequency f_{M}, where f_{M} is the frequency of the electrical and/or voltage signal applied to the second optical modulator to control operation thereof. For example, the first order portion of the first modulated manipulation signal 334A is characterized by the optical frequency f₂+f_{M}. In particular in conventional systems, the first optical modulator and the second optical modulator are both controlled by electrical and/or voltage signals characterized by the same modulator frequency f_{M}. The manipulation signals applied to the target location 225 generally also includes a zeroth order portion of the second modulated manipulation signal that is characterized by the original frequency of the second manipulation signal f₂, a second order portion of the second modulated manipulation signal 336B that is characterized by a frequency that is the original frequency of the second manipulation signal plus two times the modulator frequency f_{M} (e.g., f₂+2f_{M}), and higher order portions (e.g., third order portions and/or the like).

A frequency difference between the first order portion of the first modulated manipulation signal and the first order portion of the second modulated manipulation signal is the frequency difference between the original frequencies of the first manipulation signal (first optical frequency f₁) and the second manipulation signal (second optical frequency f₂) Δf₀=|f₁−f₂| plus two times the modulator frequency f_{M}(e.g., Δf₁=Δf₀+2f_{M}). In various embodiments, the gate frequency Δf₁ corresponds to a quantum state transition corresponding to the quantum logic gate. However, a frequency difference between the zeroth order portion of the first modulated manipulation signal and the second order portion of the second modulated manipulation signal is also the frequency difference between the original frequencies of the first manipulation signal and the second manipulation signal Δf₀ plus two times the modulator frequency f_{M} (e.g., Δf₁=Δf₀+2f_{M}). Thus, the presence of the zeroth order, second order, and/or higher order portions of the first and second modulated manipulation signals may result in undesired quantum state couplings occurring during the performance of a quantum logical operation (e.g., single qubit gate, multi-qubit and/or two-qubit gate, and/or the like). This may reduce the fidelity of the quantum logical operation.

Moreover, due to leakage of light from the optical modulators, the zeroth order portion of the first modulated manipulation signal and the second order portion of the second modulated manipulation signal, for example, may be incident on the target location at a time when a gate is not intended to be performed and cause undesired quantum state couplings (e.g., including undesired gate coupling).

FIG. 3B provides a schematic diagram in frequency space of the performance of a quantum logic operation, in accordance with an example embodiment. For example, a first optical signal 132A is modulated by a first optical modulator 130A to generate a first modulated optical signal 134A. For example, the (first order portion of the) first modulated optical signal 134A is shifted and/or decreased in frequency from its original frequency by the first frequency f_{A}, where f_{A} is the frequency of the first electrical and/or voltage signal applied to the first optical modulator 130A to control operation thereof. The optical signal applied to the target location 225 generally also includes a zeroth order portion of the first modulated optical signal that is characterized by the original frequency of the first optical signal and higher order portions (e.g., second order portions and/or the like).

A second optical signal 132B is modulated by a second optical modulator 130B to generate a second modulated optical signal 134B. For example, the (first order portion of the) second modulated optical signal 134B is shifted and/or increased in frequency from its original frequency by the second frequency f_{B}, where f_{B} is the frequency of the electrical and/or voltage signal 122B applied to the second optical modulator 130B to control operation thereof. The first frequency f_{A} and the second frequency f_{B} are different frequencies (e.g., |f_{A}−f_{B}|≥1 MHZ). The optical signal applied to the target location 225 generally also includes a zeroth order portion of the second modulated optical signal that is characterized by the original frequency of the second optical signal, a second order portion of the second modulated manipulation signal 336B that is characterized by a frequency that is the original frequency of the second optical signal plus two times the second frequency f_{B}, and higher order portions (e.g., third order portions and/or the like).

A frequency difference between the first order portion of the first modulated optical signal and the first order portion of the second modulated optical signal is the frequency difference between the original frequencies of the first optical signal and the second optical signal Δf₀ plus the first frequency f_{A} and the second frequency f_{B} (e.g., Δf₁=Δf₀+f_{A}+f_{B}). In various embodiments, the gate frequency Δf₁ corresponds to a quantum state transition corresponding to the quantum logic gate. However, because the first frequency f_{A} and the second frequency f_{B} are not equal to one another, another order frequency difference Δf₂ between the zeroth order portion of the first modulated optical signal and the second order portion of the second modulated optical signal is a different frequency difference than the gate frequency Δf₁. In particular, the other order frequency difference Δf₂=Δf₀+2f_{B}. But 2f_{B}≠f_{A}+f_{B} since f_{A}≠f_{B}. Therefore, the other order frequency difference Δf₂ does not equal the gate frequency Δf₁. Thus, the presence of the zeroth order, second order, and/or higher order portions of the first and second modulated optical signals does not result in undesired quantum state couplings occurring during the performance of a quantum logical operation (e.g., single qubit gate or multiqubit and/or two-qubit gate, and/or the like). Moreover, the undesired quantum state coupling, including undesired gate coupling at a time when the gate is not intended to be performed is prevented. Thus, in various embodiments, the fidelity of quantum logical operations is improved over conventional quantum logical operations.

In various embodiments, for the first order portion of the first modulated optical signal and the first order portion of the second modulated optical signal to be able to effectively perform and/or enact the quantum logical operation, a combination of the first frequency and the second frequency corresponds to a set frequency value fᵥ. In an example embodiment, the combination of the first frequency and the second frequency is an arithmetic combination. For example, in an example embodiment, the combination of the first frequency and the second frequency is a sum of the first frequency and the second frequency (e.g., fᵥ˜f_{A}+f_{B}˜f_{C}+f_{D}). In another example, the combination of the first frequency and the second frequency is a difference of the first frequency and the second frequency (e.g., fᵥ˜|f_{A}−f_{B}|˜|f_{C}−f_{D}|).

The set frequency value corresponds to a quantum state transition that corresponds to the quantum logical operation. For example, the set frequency value fᵥ is determined by the difference between the gate frequency Δf₁ and the frequency difference between the original frequencies of the first optical signal and the second optical signal Δf₀ (e.g., fᵥ=Δf₁−Δf₀). The gate frequency Δf₁ is determined based on and/or is equal to the frequency difference between the quantum states coupled to one another by the quantum logical operation. For example, the quantum logical operation couples a first quantum state having a first energy to a second quantum state having a second energy such that the energy difference between the two coupled quantum states is ΔE and ΔE=hΔf₁ where h is Planck's constant. Thus, in an example embodiment, the set frequency value fᵥ=ΔE/h−Δf₀. In an example embodiment, the gate frequency Δf₁ is (near) detuned from the frequency difference between the quantum states coupled to one another by the quantum logical operation (e.g., ΔE=hΔf₁±δ, where δ is small compared to ΔE).

The combination of the first frequency and the second frequency is said to correspond to the set frequency value fᵥ when a difference between the combination of the first frequency and the second frequency satisfies a threshold criterium. For example, when the difference between the combination of the first frequency and the second frequency and the set frequency value is less than a threshold frequency difference, the combination of the first frequency and the second frequency corresponds to the set frequency value. For example, in an example embodiment where the combination of the first frequency f_{A} and second frequency f_{B} is the sum thereof, when |fᵥ−(f_{A}+f_{B})|<fₜₕᵣₑₛₕ, where fₜₕᵣₑₛₕ is the threshold frequency difference, the combination of the first frequency and the second frequency corresponds to the set frequency value fᵥ. In various embodiments, the threshold frequency difference is smaller than the frequency difference between the first frequency and the second frequency (e.g., fₜₕᵣₑₛₕ<|f_{A}−f_{B}|). For example, in various embodiments, the threshold frequency difference is 1 MHz or less (e.g., 750 or 500 kHz).

Thus, in various embodiments, for each pair of voltage signal sources 120 configured to be operated in concert to, at least in part, cause the performance of a quantum logical operation, the frequencies of the electrical and/or voltage signals 122 generated thereby are relationally constrained to have a frequency combination that corresponds to the set frequency value and to have a frequency difference that is greater than or equal to 1 MHZ (e.g., greater than or equal to 5 MHz, in some embodiments, and as large as 50-100 MHz in some embodiments).

In an example embodiment, more than two voltage signal sources 120 (e.g., three or fourth voltage signal sources) are configured to be operated in concert to, at least in part, cause the performance of a quantum logical operation. For example, in an example embodiment, a first optical modulator 130A is replaced with two modulators that may be operated at the same or different frequencies. A combination (e.g., sum or difference, as appropriate for the embodiment) of the frequencies at which those two modulators are operated at replaces the first frequency when determining whether the combination of the first frequency and the second frequency corresponds to the set frequency value. For example, in various embodiments, the first frequency corresponds to the change in the optical frequency of the (first order portion of the) first optical beam due to the modulators included in the corresponding beam path system 66. For example, in an example embodiment, the first modulator is replaced with two modulators that are respectively operated at a fifth frequency f₅ and a sixth frequency f₆. When the two modulators are operated so as to change the optical frequency of the optical beam modulated by the two modulators by the sum of the fifth frequency f₅ and the sixth frequency f₆, the sum of the fifth frequency f₅ and the sixth frequency f₆ is used in place of the first frequency when determining whether the combination of the first frequency and the second frequency corresponds to the set frequency value. When the two modulators are operated so as to change the optical frequency of the optical beam modulated by the two modulators by the difference of the fifth frequency f₅ and the sixth frequency f₆, the difference of the fifth frequency f₅ and the sixth frequency f₆ is used in place of the first frequency when determining whether the combination of the first frequency and the second frequency corresponds to the set frequency value. Similarly, the second optical modulator 130B could be replaced by two or more modulators and the total change to the optical frequency of the (first order portion of the) second optical beam due to the modulators included in the respective beam path system 66 would be used in place of the second frequency when determining whether the combination of the first frequency and the second frequency corresponds to the set frequency value.

For example, in an example embodiment, the voltage signal sources 120 are organized into one or more sets of voltage signal sources. A set of the one or more sets of voltage signal sources includes one or more first voltage signal sources and one or more second voltage signal sources. The controller is configured to cause the one or more first voltage signal sources and the one or more second voltage signal sources to generate respective voltage signals characterized by respective frequencies. The respective voltage signals generated by the one or more first voltage signal sources are applied to respective optical modulators along a first beam path to collectively modify (e.g., increase or decrease) the optical frequency of an optical beam traversing the first beam path by a first frequency. The respective voltage signals generated by the one or more second voltage signal sources are applied to respective optical modulators along a second beam path to collectively modify (e.g., increase or decrease) the optical frequency of an optical beam traversing the second beam path by a second frequency. Each of the respective frequencies are different from one another. A combination of the first frequency and the second frequency corresponds to a set frequency value, and the first frequency is different from the second frequency.

In various embodiments, the controller 30 causes the quantum computer 210 to perform a quantum logic operation on one or more quantum objects by causing the confinement apparatus 220 to confine the one or more quantum objects at a target location 225. The controller 30 causes a first manipulation source 64A to generate and provide a first optical signal 132A and a second manipulation source 64B to generate and provide a second optical signal 132B. For example, the first manipulation source 64A and the second manipulation source 64B are respective lasers, in an example embodiment, and the controller 30 may control operation thereof by providing executable instructions to the respective laser drivers. The controller 30 provides a first controlling signal 112A to the first voltage signal source 120A to control operation of the first voltage signal source 120A such that the first voltage signal source 120A generates a first electrical and/or voltage signal 122A characterized by a first frequency f_{A}. The controller 30 provides a second controlling signal 112B to the second voltage signal source 120B to control operation of the second voltage signal source 120B such that the second voltage signal source 120B generates a second electrical and/or voltage signal 122B characterized by a second frequency f_{B}. The first frequency f_{A} and second frequency f_{B} have a frequency combination that corresponds to a set frequency value configured to cause the desired quantum state coupling configured to enact the quantum logical operations. Moreover, the first frequency f_{A} and the second frequency f_{B} have a non-zero frequency difference (e.g., of at least 1 MHz or more). The respective optical modulators 130 modulate the respective optical signals 132 based on the respective frequencies of the respective electrical and/or voltage signals 122 to provide respective modulated optical signals 134 that are incident on the target location 225 at the same time and/or overlapping in time to enact the quantum logical operation.

In an example embodiment, each of the operational frequencies of the optical modulators 130 are different from the set frequency value. For example, in various embodiments, none of the first frequency f_{A}, second frequency f_{B}, third frequency f_{C}, or fourth frequency f_{D} is within a buffer range of the set frequency value. For example, in an example embodiment, the set frequency value is 400 MHz and the buffer range is 300 to 500 MHz such that none of the first frequency, second frequency, third frequency, or fourth frequency have values within the buffer range of 300 to 500 MHz. In various embodiments, the size of the buffer range is configured such that without any filtering to remove crosstalk, the operational frequency of a modulator is different enough from the set frequency value to not enable crosstalk-caused light leaked from a modulator to cause undesired quantum logical operations to be performed.

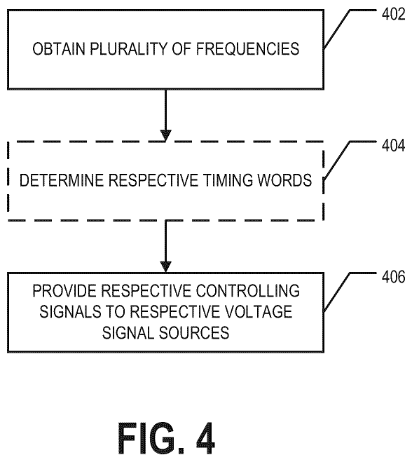

FIG. 4 provides a flowchart of processes, procedures, operations, and/or the like performed by the controller 30 to cause performance of a quantum logic operation using a frequency-splayed multi-channel system 100 and/or quantum computing system 200, in accordance with an example embodiment. Starting at step 402, the controller 30 obtains a plurality of frequencies. For example, a respective frequency of the plurality of frequencies is assigned to each channel of the frequency-splayed multi-channel system. For example, a user may operate a classical computing entity 10 to provide and/or program a plurality of frequencies with each frequency assigned to a respective channel. The computing entity 10 may then provide (e.g., transmit) the plurality of frequencies and the respective channel assignments such that the controller receives the plurality of frequencies and respective channel assignments. In another example, the controller 30 determines the plurality of frequencies based on a frequency range within which the voltage signal sources 120 are able to operate, a number of voltage signal sources 120, a number of voltage signal sources 120 mounted within a common chassis, frame, or mounting block 110, and/or the like and assigns each and of the plurality of frequencies to a respective channel. In an example embodiment, the voltage signal sources are each hardwired to generate signals of a respective frequency. For example, the controller 30 may obtain the plurality of frequencies by receiving at least a portion of the specifications of the respective voltage signal sources 120.

In various embodiments, the respective frequencies of the plurality of frequencies are assigned to respective channels and/or voltage signal sources 120 such that the respective frequencies assigned to adjacent and/or nearest neighbor voltage signal sources have a frequency difference of 1 MHz or more. For example, in an example embodiment, the first frequency f_{A} is 195 MHz, the second frequency f_{B} is 205 MHZ, the third frequency f_{C} is 195 MHz, and the fourth frequency f_{D} is 205 MHz. In another example, the first frequency f_{A} is 190 MHZ, the second frequency f_{B} is 210 MHZ, the third frequency f_{C} is 190 MHZ, and the fourth frequency f_{D} is 210 MHZ.

In an example embodiment, the respective frequencies of the plurality of frequencies are assigned to respective channels and/or voltage signal sources 120 such that the respective frequencies assigned to adjacent and/or nearest neighbor voltage signal sources have a frequency difference of 1 MHz or more and the respective frequencies assigned to non-nearest neighbor voltage signal sources have a frequency difference of 1 MHz or more. For example, in an example embodiment, the first frequency f_{A} is 195 MHz, the second frequency f_{B} is 205 MHZ, the third frequency f_{C} is 194 MHZ, and the fourth frequency f_{D} is 206 MHz. In another example, the first frequency f_{A} is 195 MHz, the second frequency f_{B} is 205 MHZ, the third frequency f_{C} is 190 MHz, and the fourth frequency f_{D} is 210 MHZ.

In an example embodiment, the frequency combination of the first and second frequencies and the frequency combination of the third and fourth frequencies both correspond to the set frequency value configured to correspond to a desired quantum state coupling used to perform a quantum logic operation. For example, the voltage signal sources 120 may be organized into pairs with each pair configured to be used in the performance of a particular quantum logical operation at a particular target location 225 defined by the confinement apparatus 220. The frequency combination of the frequencies that characterize the electrical and/or voltage signals of a respective pair of voltage signal sources corresponds to a set frequency value that is configured to correspond to a desired quantum state coupling used to perform the particular quantum logic operation.

At step 404, the controller 30 determines a respective tuning word for each channel. For example, the controller 30 provides and/or transmits a respective tuning word to each voltage signal source 120 (e.g., DDS) to cause the respective voltage signal source 120 to generate a respective electrical and/or voltage signal 122 characterized by the respective frequency assigned to the respective channel.

For example, in an example embodiment where the voltage signal sources 120 are DDSs, the controller 30 may determine a respective tuning word corresponding to the respective frequency for each channel and/or voltage signal source 120. For example, the respective frequency fᵢ is related to the respective tuning word Mᵢ through the relationship

$${f}_{i} = \frac{{M}_{i} * {f}_{c}}{{2}^{N}} ,$$

where Mᵢ is the tuning word, f_{c} is the system clock frequency (e.g., the frequency of a clock of the controller 30 or a frequency of a clock local to the respective voltage signal source), and N is the length (e.g., number of bits) of the phase accumulator of the respective voltage signal source 120.

At step 406, the controller 30 provides respective control signals 112 to each of the voltage signal sources 120 to cause the respective voltage signal sources 120 to generate and/or provide electrical and/or voltage signals characterized by the respective frequency assigned to the respective voltage signal source 120. For example, in various embodiments, the controller 30 provides respective control signals 112 that program the respective voltage signal sources 120 to cause the respective voltage signal sources 120 to generate and/or provide electrical and/or voltage signals characterized by the respective frequency assigned to the respective voltage signal source 120. For example, in an example embodiment, the respective control signals 112 include respective tuning words.

The respective voltage signal sources 120 generate respective electrical and/or voltage signals 122 that are provided to respective additional components via respective electrical connections 124. In various embodiments, the respective electrical and/or voltage signals 122 are provided to the respective additional components to control operation, at least in part, of the respective additional components.

In an example embodiment, the additional components are optical modulators 130. For example, the optical modulators 130 are configured to modulate optical signals 132 based on respective electrical and/or voltage signals 122 applied thereto to generate and/or provide respective modulated optical signals 134. In an example embodiment, the respective modulated optical signals are used to perform and/or enact quantum logical operations at respective target locations 225. For example, a pair of modulated optical signals 134 (of channels having a frequency combination corresponding to the set frequency value and a frequency difference of at least 1 MHZ) may be incident on a particular target location 225 at the same time (e.g., overlapping in time at least in part) to cause the occurrence of a particular quantum logical operation on one or more quantum objects disposed at the target location 225 at that time.

### Example Filtering of Crosstalk

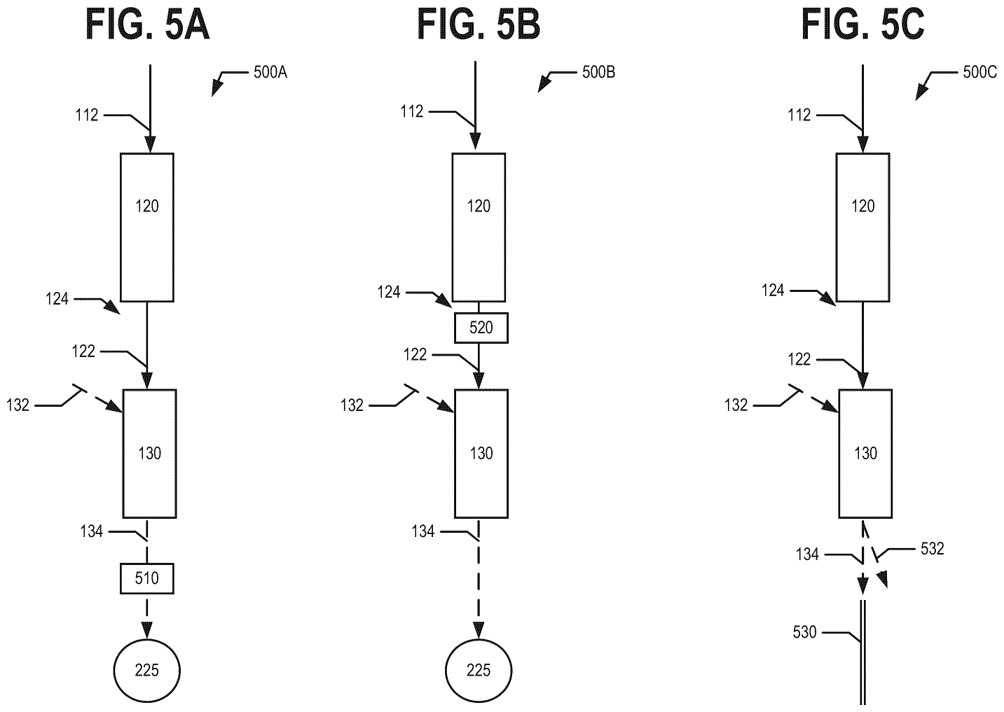

In various embodiments, the effects of crosstalk on the performance of the frequency-splayed multi-channel system are reduced and/or diminished through the use of electrical, optical, and/or spatial filtering. In particular, the desired frequency of a particular channel is known (e.g., the frequency assigned to that channel). Crosstalk between channels results in signals of different frequencies (e.g., other than the desired/assigned frequency) being introduced into the electrical connection(s) 124 of the channel and/or the modulated optical signal generated by the channel. FIG. 5A illustrates optical filtering of an example channel 500A. FIG. 5B illustrates electrical filtering of an example channel 500B. FIG. 5C illustrates spatial filtering of an example channel 500C.

As shown in FIG. 5A, the channel 500A includes a voltage signal source 120 that is configured to receive a control signal 112 (that was generated and provided by the controller 30) and generate an electrical and/or voltage signal 122 characterized by a frequency indicated by the control signal 112. The channel 500A further includes an additional component in the form of an optical modulator 130. The optical modulator 130 is configured to receive an optical signal 132 (e.g., via a waveguide, optical fiber, or free space propagation) and to have the electrical and/or voltage signal 122 applied thereto. The optical modulator 130 is further configured to modulate the optical signal 132 based at least in part on the electrical and/or voltage signal applied to the optical modulator 130 to generate and provide a modulated optical signal 134. For example, the optical modulator may modulate the optical signal 132 to increase and/or decrease the optical frequency of the optical signal by the frequency of the electrical and/or voltage signal 122.

The channel 500A further includes an optical filter 510. The optical filter 510 is configured to filter the modulated optical signal 134 to pass the first order portion of the modulated optical signal 134 and to remove portions of the modulated optical signal that were generated due to crosstalk between channel 500A and one or more other channels of the frequency-splayed multi-channel system 100. The optical filter 510 may be a low pass filter, a high pass filter, a bandpass filter, a grating, a cavity, and/or the like. For example, the optical frequency of the optical signal 132 is f_{O} and the frequency characterizing the electrical and/or voltage signal 122 is fᵢ. Thus, the first order portion of the modulated optical signal is f_{O}+fᵢ or f_{O}−fᵢ. In various embodiments, the optical filter 510 is configured to filter out light that is characterized by a frequency that is greater than f_{O}+fᵢ+Δ or less than f_{O}−f₁−Δ, where Δ is a non-zero frequency.

In various embodiments, the non-zero frequency Δ corresponds and/or is equal to the smallest voltage difference between voltage signal sources of the frequency-splayed multi-channel system 100. For example, the non-zero frequency Δ may correspond and/or be equal to the non-nearest neighbor voltage signal source frequency difference (e.g., 1 MHz or more in an example embodiment) of the frequency-splayed multi-channel system 100. In another example, the non-zero frequency Δ may correspond and/or be equal to the adjacent and/or nearest neighbor voltage signal source frequency difference (e.g., 1 MHz or more in an example embodiment) of the frequency-splayed multi-channel system 100.

As shown in FIG. 5B, the channel 500B includes a voltage signal source 120 that is configured to receive a control signal 112 (that was generated and provided by the controller 30) and generate an electrical and/or voltage signal 122 characterized by a frequency indicated by the control signal 112. The channel 500B further includes an additional component in the form of an optical modulator 130. The optical modulator 130 is configured to receive an optical signal 132 (e.g., via a waveguide, optical fiber, or free space propagation) and to have the electrical and/or voltage signal 122 applied thereto. The optical modulator 130 is further configured to modulate the optical signal 132 based at least in part on the electrical and/or voltage signal applied to the optical modulator 130 to generate and provide a modulated optical signal 134. For example, the optical modulator may modulate the optical signal 132 to increase and/or decrease the optical frequency of the optical signal by the frequency of the electrical and/or voltage signal 122.

The channel 500B further includes an electrical filter 520. The electrical filter 520 is configured to filter the electrical and/or voltage signal 122 prior to the electrical and/or voltage signal 122 being provided to the optical modulator 130. In various embodiments, the electrical filter 520 may be located at any point along the electrical connection 124 between the voltage signal source 120 and the optical modulator 130. In various embodiments, the electrical filter 520 is configured to remove the crosstalk between channel 500B and one or more other channels of the frequency-splayed multi-channel system 100. The electrical filter 520 may be a low pass filter, a high pass filter, a bandpass filter, and/or the like. For example, the frequency characterizing the electrical and/or voltage signal 122 of channel 500B is fᵢ and the electrical filter 520 is configured to filter out portions of the electrical and/or voltage signal 122 that are characterized by a frequency that is greater than fᵢ+Δ or less than fᵢ+Δ, where Δ is a non-zero frequency.

In various embodiments, the non-zero frequency Δ corresponds and/or is equal to the smallest voltage difference between voltage signal sources of the frequency-splayed multi-channel system 100. For example, the non-zero frequency Δ may correspond and/or be equal to the non-nearest neighbor voltage signal source frequency difference (e.g., 1 MHz or more in an example embodiment) of the frequency-splayed multi-channel system 100. In another example, the non-zero frequency Δ may correspond and/or be equal to the adjacent and/or nearest neighbor voltage signal source frequency difference (e.g., 1 MHz or more in an example embodiment) of the frequency-splayed multi-channel system 100.

As shown in FIG. 5C, the channel 500C includes a voltage signal source 120 that is configured to receive a control signal 112 (that was generated and provided by the controller 30) and generate an electrical and/or voltage signal 122 characterized by a frequency indicated by the control signal 112. The channel 500B further includes an additional component in the form of an optical modulator 130. The optical modulator 130 is configured to receive an optical signal 132 (e.g., via a waveguide, optical fiber, or free space propagation) and to have the electrical and/or voltage signal 122 applied thereto. The optical modulator 130 is further configured to modulate the optical signal 132 based at least in part on the electrical and/or voltage signal applied to the optical modulator 130 to generate and provide a modulated optical signal 134. For example, the optical modulator may modulate the optical signal 132 to increase and/or decrease the optical frequency of the optical signal by the frequency of the electrical and/or voltage signal 122.

The modulated optical signal 134 is filtered using spatial filtering. For example, an optical fiber 530 is disposed at a location along the beam path along which light of a desired frequency or frequency range exits the optical modulator 130. For example, the optical modulator 130 is configured such that light modulated at different frequencies exits the optical modulator 130 at different angles. For example, the portion of the optical signal 132 that was modulated at the frequency assigned to the channel 500C (the modulated optical signal 134) exits the optical modulator 130 at an angle such that the modulated optical signal 134 is coupled into optical fiber 530. A portion of the optical signal 132 that was modulated at a frequency assigned to a neighboring channel (e.g., as a result of crosstalk between the channel 500C and the neighboring channel) 432 exits the optical modulator 130 at a different angle than the modulated optical signal 134. Thus, the portion of the optical signal 132 that was modulated at a frequency assigned to a neighboring channel (e.g., as a result of crosstalk between the channel 500C and the neighboring channel) 432 is not coupled into the optical fiber 530. The optical fiber 530 may be part of the beam path system 66 configured to transport the modulated optical signal 134 at least a portion of the way to the target location 225.

In various embodiments, instead of coupling the modulated optical signal 134 into an optical fiber 530, another form of spatial filtering may be used. For example, a light absorber having a slit or aperture at a location that is configured to allow the modulated optical signal 134 pass through the slit or aperture while light exiting the optical modulator 130 at different angles is absorbed, reflect, deflected, and/or the like such that only the modulated optical signal 134 reaches the target location 225.

In various embodiments, the optical, electrical, and/or spatial filtering of inter-channel crosstalk is enabled because different channels are operating (e.g., generating and providing respective electrical and/or voltage signals of different frequencies) such that the crosstalk can be distinguished from the desired signal for the respective channel in frequency space.

### Technical Advantages

In conventional multi-channel systems, voltage signal sources configured to generate electrical and/or voltage signals that are to be used to perform the same task (e.g., control operation of similar optical modulators configured to perform similar tasks in the multi-channel system) are operated to generate electrical and/or voltage signals of the same frequency. For example, a plurality of 200 MHz AOMs may be operated to generate electrical and/or voltage signals of 200 MHz. When the voltage signal sources are located close to one another or the electrical wires configured to enable electrical communication between respective voltage signal sources and respective additional components are close to one another, electrical crosstalk may occur between different electrical channels. Such electrical crosstalk between different electrical channels may degrade the operations of the multi-channel system. For example, when the multi-channel system is a quantum computer that performs operations that are controlled, at least in part, based on the electrical and/or voltage signals generated by respective voltage signal sources, the integrity and/or fidelity of the performed operations may be degraded and/or reduced as a result of the electrical crosstalk between the different electrical channels. Therefore, technical problems exist regarding operation of multi-channels systems.

Additionally, crosstalk between electrical signals that are being applied to optical modulators can cause an optical modulator to provide light of the first diffracted order when the electrical signal intended to control operation of the optical modulator is configured to cause the optical modulator to not provide light (e.g., the electrical signal intended to control operation of the optical modulator is configured to cause the optical modulator to be in an off state). This leads to additional noise and undesired light scattering in the multi-channel system.

Various embodiments provide technical solutions to these technical problems. For example, various embodiments provide frequency-splayed multi-channel systems. For example, the voltage signal sources located adjacent to one another are operated to generate electrical and/or voltage signals characterized by different frequencies, in various embodiments. In an example embodiment, each of the plurality of voltage signal sources is operated to generate a respective electrical and/or voltage signal that is characterized by a different frequency than the other electrical and/or voltage signals generated by the other voltage signal sources of the plurality of voltage signal sources. For example, a first voltage signal source is operated to generate an electrical and/or voltage signal characterized by a first frequency and a second voltage signal source is operated to generate an electrical and/or voltage signal characterized by a second frequency, where the first and second frequencies are different from one another. For example, the frequency difference between the first frequency and the second frequency is at least 1 MHZ (e.g., in a range of 1 MHz to 100 MHz, in an example embodiment). Thus, any crosstalk between the first channel comprising the first voltage signal source and the second channel comprising the second voltage signal source may be removed and/or dampened using various filtering techniques. Thus, the effect of any crosstalk between the first channel and the second channel (e.g., on the integrity and/or fidelity of any operations controlled, at least in part, via the first channel and/or the second channel) is reduced and/or diminished. Therefore, various embodiments provide technical advantages and improvements to the operating of multi-channel systems.

Moreover, in conventional quantum computers that use optical modulators to, at least in part, control provision of two or more optical signals to a target location to enact a quantum logical operation (e.g., single qubit gate, a multi-qubit and/or two-qubit gate, and/or the like), leaked light from one or more of the optical modulators of various orders may cause undesired coupling between various quantum states of the quantum objects disposed at the target location.

For example, when an optical beam is modulated by an optical modulator, the majority of the optical beam is modulated in accordance with the frequency that characterizes the electrical and/or voltage signal applied to the optical modulator. This is referred to as first order modulation. Some of the optical beam is modulated in accordance with the second harmonic of the frequency (e.g., two times the frequency) that characterizes the electrical and/or voltage signal applied to the optical modulator. This is referred to as second order modulation. Some of the optical beam may not be modulated at all, which is referred to as zeroth order modulation. The desired modulated optical signals are the first order modulated optical signals. However, the leaked light (e.g., zeroth order portion of the modulated optical signals, second order portion of the modulated optical signals, third order portion of the modulated optical signals, etc.) will also be incident on the multiple quantum objects disposed at the target location. This leaked light may result in undesired coupling of quantum states of the multiple quantum objects. For example, the zeroth order portion of the first modulated optical signal and the second order portion of the second modulated optical signal may interact with the quantum objects disposed at the target location to cause an undesired coupling quantum states of the multiple quantum objects.

In various scenarios, the first modulated optical signal and second modulated optical signal are provided to the target location to cause performance of a quantum logic operation. For example, the (first order portion of the) first modulated optical signal and the (first order portion of the) second modulated optical signal being incident on the multiple quantum objects disposed at the target location causes a multiple qubit (e.g., two-qubit) gate to be performed on the multiple quantum objects. The undesired coupling of the quantum states of the multiple quantum objects caused by the leaked light being incident on the multiple quantum objects disposed at the target location may reduce and/or degrade the fidelity of the quantum logic operation performed on the multiple quantum objects. Similar undesired coupling of quantum states of a quantum object embodying a qubit may reduce and/or degrade the fidelity of single qubit gate. Thus, technical problems exist regarding performing high fidelity quantum logical operations.

Various embodiments provide technical solutions to these technical problems. For example, in an example embodiment, a first voltage signal source is operated to generate a first electrical and/or voltage signal characterized by a first frequency and that is used to control the operation of a first optical modulator. A second voltage signal source is operated to generate a second electrical and/or voltage signal characterized by a second frequency and that is used to control the operation of a second optical modulator. The first optical modulator modulates a first optical signal so as to provide a first (first order) modulated optical signal that has a frequency that is increased, with respect to the frequency of the first optical signal, by the first frequency. The second optical modulator modulates a second optical signal so as to provide a second (first order) modulated optical signal that has a frequency that is decreased, with respect to the frequency of the second optical signal, by the second frequency. In various embodiments, the combination of the first frequency and the second frequency corresponds to a set frequency value that is configured to enable that (first order) modulated optical signals to cause the gate coupling so as to enact the quantum logical operation (e.g., single qubit gate, multi-qubit and/or two-qubit gate, and/or the like). The first frequency and the second frequency are different from one another (e.g., have a frequency difference of at least 1 MHZ). Since the first frequency and the second frequency are not equal to one another, the ability of the leaked light to cause undesired coupling of quantum states of the quantum objects is decreased and/or reduced.

Moreover, the splaying of the frequencies and filtering reduces the first order light emitted by an optical modulator that is intended to be “off” and/or to not provide an optical beam at that time.

Therefore, various embodiments provide technical advantages and improvements to the operation of systems having multiple electrical channels, quantum computers and high fidelity quantum logical operations.

### Exemplary Controller

Various embodiments provide frequency-splayed multi-channel systems 100 and/or quantum computers 210 comprising frequency-splayed multi-channel systems 100. In an example embodiment, the system is a quantum charge-coupled device (QCCD)-based quantum computer 210 or other quantum computer and uses the frequency-splayed multi-channel system 100 for performing quantum logical operations (e.g., single qubit gates, multi-qubit or two-qubit gates, and/or the like). In various embodiments, the system (e.g., frequency-splayed multi-channel system 100 and/or quantum computer 210) further comprises a controller 30 configured to control various elements of the system. For example, the controller 30 may be configured to control the voltage signal sources 120, a cryogenic system and/or vacuum system for controlling the temperature and pressure within the cryogenic and/or vacuum chamber 40, manipulation sources 64 (e.g., 64A, 64B, 64C), active components of beam path systems 66 (e.g., optical modulators 130), magnetic field sources, and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects confined by the confinement apparatus, and/or read and/or detect a quantum state of one or more quantum objects confined by the confinement apparatus 220.

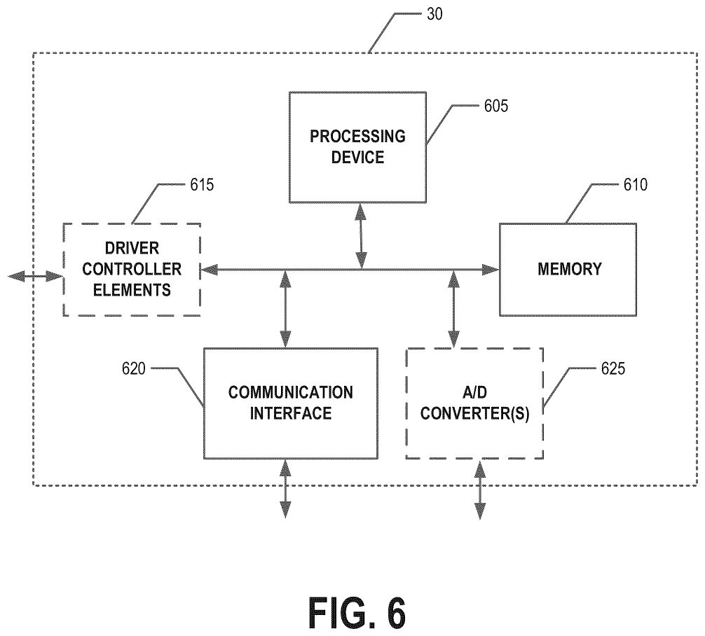

As shown in FIG. 6, in various embodiments, the controller 30 may comprise various controller elements including one or more processing devices 605, memory 610, driver controller elements 615, a communication interface 620, analog-digital converter elements 625, and/or the like. For example, the one or more processing devices 605 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 605 of the controller 30 comprises a clock and/or is in communication with a clock. In various embodiments, this clock defines the clock cycles and/or clock frequency of the system.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store frequencies assigned to respective channels, qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 210 (e.g., voltages sources 50, manipulation sources 64, magnetic field sources, and/or the like) to cause a controlled evolution of quantum states of one or more quantum objects, detect and/or read the quantum state of one or more quantum objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes and/or RF electrodes of the confinement apparatus. In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system. For example, the controller 30 may comprise one or more analog-digital converter elements 625 configured to receive signals from one or more detectors, optical receiver components, calibration sensors, and/or the like.

In various embodiments, the controller 30 may comprise a communication interface 620 for interfacing and/or communicating with one or more computing entities 10. For example, the controller 30 may comprise a communication interface 620 for receiving executable instructions, command sets, and/or the like from the computing entity 10 and providing output received from the quantum processor 215 (e.g., via the optics collection system) and/or the result of a processing the output (received from the quantum processor 215) to the computing entity 10. In various embodiments, the computing entity 10 and the controller 30 may communicate via a direct wired and/or wireless connection and/or one or more wired and/or wireless networks 20.

### Exemplary Computing Entity

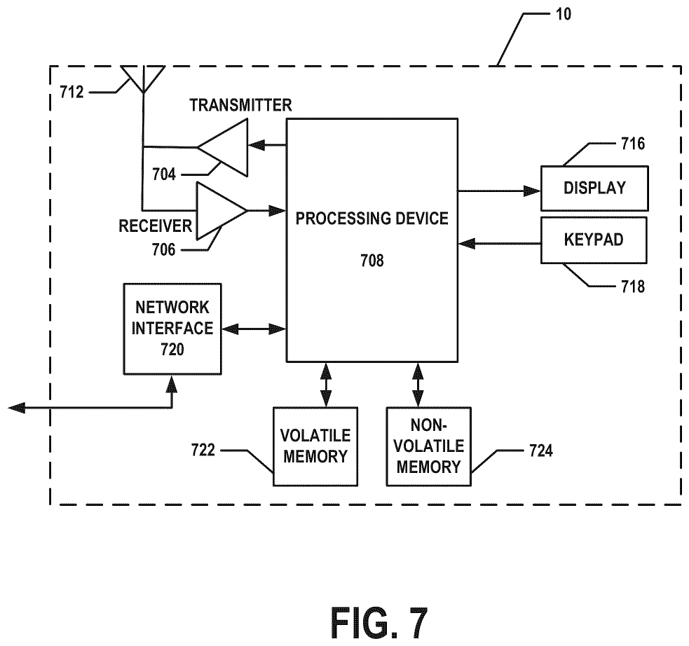

FIG. 7 provides an illustrative schematic representative of an example computing entity 10 that can be used in conjunction with embodiments of the present invention. In various embodiments, a computing entity 10 is configured to allow a user to provide input to the quantum computer 210 (e.g., via a user interface of the computing entity 10) and receive, display, analyze, and/or the like output from the quantum computer 210.

As shown in FIG. 7, a computing entity 10 can include an antenna 712, a transmitter 704 (e.g., radio), a receiver 706 (e.g., radio), and a processing device 708 that provides signals to and receives signals from the transmitter 704 and receiver 706, respectively.

The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 720 configured to communicate via one or more wired and/or wireless networks 20.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like. For example, the user interface device may enable a user to program a plurality of frequencies and assign each of the plurality of frequencies to a respective channel and/or voltage signal source.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for performing a quantum logic gate, the method performed by a controller configured to control operation of one or more components of a quantum computer, the method comprising:
controlling operation of a first voltage signal source to generate a first voltage signal having a first frequency; and
controlling operation of a second voltage signal source to generate a second voltage signal having a second frequency,
wherein:
the first voltage signal is provided to a first optical modulator configured to modulate a first optical signal based at least in part on the first frequency,
the second voltage signal provided to a second optical modulator configured to modulate a second optical signal based at least in part on the second frequency,
a combination of the first frequency and the second frequency corresponds to a set frequency value, and
the first frequency is different from the second frequency.

2. The method of claim 1, wherein a sum of (a) a frequency difference between a frequency of the first optical signal and a frequency of the second optical signal and (b) the set frequency value corresponds to a quantum state transition corresponding to the quantum logic gate.

3. The method of claim 1, wherein the first voltage signal source is a first direct digital synthesizer and controlling operation of the first voltage signal source comprises providing, by the controller, a tuning word to the first direct digital synthesizer.

4. A system comprising:
one or more pairs of voltage signal sources; and
a controller configured to control operation of the one or more pairs of voltage signal sources,
wherein:
the one or more pairs of voltage signal sources comprises a first pair of voltage signal sources that comprises a first voltage signal source and a second voltage signal source,
the controller is configured to cause the first voltage signal source of the first pair of voltage signal sources to generate a first voltage signal characterized by a first frequency,
the controller is configured to cause the second voltage signal source of the first pair of voltage signal sources to generate a second voltage signal characterized by a second frequency,
a combination of the first frequency and the second frequency corresponds to a set frequency value, and
the first frequency is different from the second frequency.

5. The system of claim 4, wherein:
the one or more pairs of voltage signal sources further comprise a second pair of voltage signal sources, the second pair of voltage signal sources comprising a third voltage signal source and a fourth voltage signal source,
the controller is configured to cause the third voltage signal source of the second pair of voltage signal sources to generate a third voltage signal characterized by a third frequency,
the controller is configured to cause the fourth voltage signal source of the second pair of voltage signal sources to generate a fourth voltage signal characterized by a fourth frequency,
a combination of the third frequency and the fourth frequency corresponds to the set frequency value, and
the third frequency is different from the fourth frequency.

6. The system of claim 5, wherein each of the first frequency, the second frequency, the third frequency, and the fourth frequency are different from one another.

7. The system of claim 6, wherein a respective frequency difference between a respective two of the first frequency, the second frequency, the third frequency, and the fourth frequency is in a range of 1 MHz to 100 MHz.

8. The system of claim 4, wherein at least two voltage signal sources of the one or more pairs of voltage signal sources are mounted within a chassis and the controller is configured to cause the at least two voltage signal sources to generate respective voltage signals at respective frequencies that are different from one another.

9. The system of claim 4, wherein the controller is configured to control operation of a first additional component of the system via application of the first voltage signal to the first additional component and to control operation of a second additional component of the system via application of the second voltage signal to the second additional component.

10. The system of claim 9, wherein the first additional component comprises a first optical modulator and the second additional component comprises a second optical modulator.

11. The system of claim 10, the first voltage signal is applied to the first optical modulator to cause the first optical modulator to modulate a first optical signal to provide a first modulated optical signal and the second voltage signal is applied to the second optical modulator to cause the second optical modulator to modulate a second optical signal to provide a modulated optical signal, wherein the first modulated optical signal and the second modulated optical signal are applied to a target location to cause a quantum logic gate to be performed on one or more quantum objects disposed at the target location.

12. The system of claim 11, wherein a sum of (a) a frequency difference between a frequency of the first optical signal and a frequency of the second optical signal and (b) the set frequency sum value corresponds to a quantum state transition corresponding to the quantum logic gate.

13. The system of claim 11, wherein the first modulated optical signal is filtered using at least one of spatial filtering or optical filtering.

14. The system of claim 13, wherein the at least one of spatial filtering or optical filtering is performed by at least one of (a) coupling the first modulated optical signal into an optical fiber configured to carry the first modulated optical signal along at least a portion of an optical path from the first optical modulator to the target location, (b) use of a grating, (c) use of cavity, or (d) use of an optical filter.

15. The system of claim 9, wherein the first voltage signal is applied to the first additional component via a first electrical connection and the second voltage signal is applied to the second additional component via a second electrical connection.

16. The system of claim 15, wherein the first electrical connection comprises a filter configured to pass a portion of an electrical signal carried by the first electrical connection and characterized by the first frequency and to dampen a portion of the electrical signal carried by the first electrical connection and characterized by the second frequency.

17. The system of claim 4, wherein a frequency difference between the first frequency and the second frequency is in a range of 1 MHz and 100 MHz.

18. The system of claim 4, wherein the controller provides a first tuning word to cause the first voltage signal source to cause the first voltage source to generate the first voltage signal with the first voltage.

19. A system comprising:
a plurality of voltage signal sources mounted in a chassis, and
a controller configured to control operation of the voltage signal sources to cause the voltage signal sources to generate respective voltage signals characterized by respective frequencies,
wherein:
the plurality of voltage signal sources comprises a first voltage signal source, a second voltage signal source, and a third voltage signal source,
the first voltage signal source is adjacent the second voltage signal source and the third voltage signal source is adjacent to the second voltage signal source such that the second voltage signal source is disposed between the first voltage signal source and the third voltage signal source,
the controller causes the first voltage signal source to generate a first voltage signal characterized by a first frequency, the second voltage signal source to generate a second voltage signal characterized by a second frequency, and the third voltage signal source to generate a third voltage signal characterized by a third frequency,
the first frequency is different from the second frequency, and
the second frequency is different from the third frequency.

20. The system of claim 19, wherein a frequency difference between the first frequency and the second frequency is larger than a frequency difference between the first frequency and the third frequency.

21. A system comprising:
one or more sets of voltage signal sources; and
a controller configured to control operation of the one or more sets of voltage signal sources,
wherein: the one or more sets of voltage signal sources comprises one or more first voltage
signal sources and one or more second voltage signal sources,
the controller is configured to cause the one or more first voltage signal sources and the one or more second voltage signal sources to generate respective voltage signals characterized by respective frequencies,
the respective voltage signals generated by the one or more first voltage signal sources are applied to respective optical modulators along a first beam path to modify an optical beam traversing the first beam path by a first frequency,
the respective voltage signals generated by the one or more second voltage signal sources are applied to respective optical modulators along a second beam path to modify an optical beam traversing the second beam path by a second frequency,
the respective frequencies are different from one another,
a combination of the first frequency and the second frequency corresponds to a set frequency value, and
the first frequency is different from the second frequency.
